(19) United States
(12) Patent Application Publication
(10) Pub. No.: US 2003/0203210 A1
(43) Pub. Date: Oct. 30, 2003

(54) Barrier coatings and methods of making same

(75) Inventors: Gordon Lee Graff, West Richland, WA (US); Mark Edward Gross, Pasco, WA (US); Wendy D. Bennett, Kennewick, WA (US); Michael Gene Hall, West Richland, WA (US); Peter Maclyn Martin, Kennewick, WA (US); Eric Sidney Mast, Richland, WA (US); John Chris Pagano, Totowa, NJ (US); Nicole Rutherford, Saratoga, CA (US); Mac R. Zumhoff, Kennewick, WA (US)

Correspondence Address: TESTA, HURWITZ & THIBEAULT, LLP, HIGH STREET TOWER, 125 HIGH STREET, BOSTON, MA, 02110, US

(73) Assignee: Vitex Systems, Inc., San Jose, CA

(21) Appl. No.: 10/135,272

(22) Filed: Apr. 30, 2002

(51) Int. Cl. B32B 27/36

(52) U.S. Cl. 428/412

(57) ABSTRACT

A multi-layer barrier coating on a flexible substrate exhibits improved resistance to gas and liquid permeation. The multi-layer barrier coating generally comprises alternating polymer and inorganic layers, and the layer immediately adjacent to the flexible substrate and the topmost isolation layer may both be inorganic layers. The surface of each deposited inorganic layers may be plasma-treated prior to the deposition of the polymer layer thereon, while the surfaces of the polymer layers are generally not plasma-treated. The multi-layer barrier coating is lightweight, preferably transparent, and has improved flexibility and resiliency, as well as resistance to cracking and delaminating

### FIELD OF THE INVENTION

The present invention generally relates to barrier coatings, and, more particularly, to barrier coatings having improved barrier properties.

### BACKGROUND OF THE INVENTION

Many different types of products, such as electronics, medical devices, and pharmaceuticals, are sensitive to gases and liquids, which can cause deterioration of the product over a period of time. In particular, various electronic devices are adversely affected by moisture that degrades insulation and initiates corrosion.

Some of these devices are particularly sensitive to the environment. For example, devices utilizing organic light-emitting materials are potential candidates for a great variety of displays, such as digital watches, telephones, laptop computers, pagers, cellular telephones, calculators and the like. Unlike inorganic semiconductor light emitting devices, organic light-emitting devices (OLEDs) are relatively inexpensive to fabricate and potentially can be manufactured on flexible polymer substrates, which may further expand their utility in displays. Indeed, the ability to use polymer substrates is critical to future generations of many electronic products and associated technologies because such substrates are lightweight, impact resistant, and inexpensive. Polymers, however, are susceptible to the permeation of oxygen and moisture in the environment. Because the component layers of OLEDs rapidly degrade upon exposure to gases and liquids, the use of OLEDs fabricated on polymer substrates is currently limited by their poor environmental stability. Stability problems typically arise in the organic layers and the low work function electrode layer. If an OLED is to be formed on a polymer substrate, it is necessary to reduce or eliminate the diffusion of oxygen and moisture through the substrate in order to avoid the degradation of the OLED and/or other components of the device subject to adverse reactions with oxygen or water.

For example, polyethylene terephthalate (PET), which is commonly used as a substrate for web processing, has an oxygen permeation rate as high as 1550 cc/m² per day per micron of thickness and a water permeation rate of 272 g/m² per day per micron of thickness. As a result, OLEDs constructed thereon may begin to degrade almost immediately due to reaction of water from the air with the cathode material. Although a transparent inorganic OLED electrode (typically indium tin oxide) located adjacent to the polymer substrate serves as a partial environmental barrier, its resistance to gas and liquid permeation is insufficient to protect sensitive layers of the OLED. Accordingly, some form of sealant coating must be applied to the polymer to achieve the required resistance to water and oxygen. In addition, the cathode layer must be hermetically sealed on the opposite side of the device to prevent water and oxygen from entering from that side and destroying the cathode. Certain display applications using environmentally sensitive display devices, such as OLEDs, typically require encapsulation that has a maximum oxygen transmission rate of 10⁻⁴ to 10⁻² cc/m²/day, and a maximum water vapor transmission rate of 10⁻⁵ to 10⁻⁶ cc/m²/day. In order to enable commercially practical use of flexible polymer substrates with OLEDs, such encapsulation needs to maintain these levels of resistance to oxygen and moisture in adverse operating conditions, and must typically also withstand the patterning processes performed upon the OLED electrodes, such as resist deposition, masking, exposure, development, and chemical etching. In particular, as those skilled in the art will recognize, it is typically desirable that such encapsulation maintain the above-referenced levels of resistance to oxygen and moisture when subjected to the following tests:

1. Temperature cycling, for example, 500 cycles at the temperature between −40° C. and 80° C.;

2. Exposure to 95% relative humidity at 60° C.;

3. Flex testing, for example, 1000 cycles on a radius of ½″ or 1″; and

4. Calcium test—less than 7% change in optical transmission (300-800 nm) when exposed to 95% relative humidity at 60° C. The calcium test is run by vacuum depositing a layer of a low work function metal (typically calcium) on a transparent glass substrate, and then installing a barrier sample over the calcium layer. The sample is then exposed in a hot humid environment (95% relative humidity at 60° C.) and examined. A loss of opacity results from calcium reacting with water and as such is indicative of the barrier failing to adequately prevent moisture permeation.

Barrier coatings have been traditionally applied to polymer substrates to reduce their gas and liquid permeability and to protect environmentally sensitive products from exposure to gases and liquids, such as oxygen and water vapor in the atmosphere or chemicals used in processing, handling, storage, and use of the product. Such coatings typically consist of a single thin layer of inorganic material, such as aluminum, aluminum oxide, silicone oxide, or silicone nitride, vacuum-deposited on polymer substrates. A single-layer inorganic coating on PET, for example, reduces the oxygen permeation rate to about 10⁻¹ to 1 cc/m²/day, and the water vapor permeation rate to about 10⁻¹ to 1 g/m²/day. While a substantial improvement over the unaltered PET, these levels are nonetheless insufficient to protect displays utilizing OLEDs from degradation.

In theory, a single high-quality oxide layer on a planarized debris-free surface should provide the desired resistance to permeation by environmental elements. In practice, however, such coatings provide insufficient protection due to, for example, unavoidable defects in the oxide layer, and particularly due to local adhesion failures between the substrate and the oxide layer during temperature cycling caused by differences in thermal coefficients of expansion.

Another coating technique that has shown promise is the Polymer Multi-Layer (PML) technique described in U.S. Pat. Nos. 4,842,893 and 4,954,371 to Yializis, and 5,260,095 to Affinito, incorporated herein by reference. Using this technique, a coating of alternating polymer and inorganic oxide layers is applied to the flexible substrate. Deposition of both types of layers can be achieved using web processing equipment at very high speeds. U.S. Pat. Nos. 5,607,789 and 5,681,666, both to Treger, et al., disclose a similar technique utilized to create a moisture barrier for an electrochemical cell tester. The claimed moisture permeability of the barrier coating described therein ranges from 0.003 to 0.023 g/m²/day. Similarly, U.S. Pat. No. 6,146,225 to Sheats et al. discloses barrier coatings which consist of a first polymer layer deposited over the environmentally sensitive device, an inorganic layer deposited on the first polymer layer by plasma enhanced chemical vapor deposition, and a second polymer layer deposited over the inorganic layer. U.S. Pat. No. 6,268,695 to Affinito discloses an environmental barrier for an OLED having of a foundation and a cover, each consisting of three vacuum-deposited layers of a first polymer layer, a ceramic layer, and a second polymer layer.

While the resistance to liquid and gas permeation of substrates having barrier coatings known in the art is considerable, the resulting films are still sufficiently permeable to limit the lifetime of the environmentally sensitive devices, particularly in applications requiring prolonged periods of operation and/or exposure to hot and humid environments. Thus, there is a need in the art of for an improved flexible lightweight environmental barrier coating.

### SUMMARY OF THE INVENTION

It is an object of the present invention to provide a multi-layer barrier coating that has an improved resistance to liquid and gas permeation sufficient to protect an environmentally sensitive device, such as, for example, an OLED, from damage by atmospheric elements.

It is another object of the present invention to provide a method of fabricating a multi-layer environmental barrier coating on a flexible substrate.

It is yet another object of the present invention to provide an efficient and inexpensive method of fabricating a multi-layer environmental barrier coating on a flexible web substrate.

Accordingly, a multi-layer environmental barrier coating having a plurality of alternating polymer and inorganic layers deposited over the flexible substrate, where the layer immediately adjacent to the substrate and the topmost layer are inorganic, is disclosed herein. Also disclosed herein are the methods of fabricating such multi-layer environmental barrier coatings.

In general, in one aspect, the invention features a multi-layer environmental barrier coating having a flexible substrate, a foundation stack and at least one barrier stack deposited over the foundation stack. The foundation stack includes a foundation barrier layer fabricated of at least one ply of a first inorganic material deposited over the substrate, and an organic layer fabricated of at least one ply of an organic material deposited over the foundation barrier layer. Each barrier stack includes a barrier layer of at least one ply of a second inorganic material, and an organic layer fabricated of at least one ply of an organic material deposited over that barrier layer. The multi-layer environmental barrier coating also includes a topmost isolation layer of a third inorganic material deposited over the barrier stack. At least one of the inorganic plies of the multi-layer environmental barrier coating is desirably plasma-treated.

The barrier-stack barrier layer may also include at least one ply of a plasma-treated fourth inorganic material. The flexible substrate may be substantially transparent. Further, the substrate may be plasma-treated, and may be fabricated of, for example, polynorbornene, polyarnide, polyethersulfone, polyimides, polyetherimide, polycarbonate, polyethelene naphthalate, polyester, and nylon. In one embodiment of the invention, the substrate is made of a polyester film. At least one side of the flexible substrate may include a functional coating selected from the group consisting of an adhesion-enhancing coating, scratch-resistant coating, anti-fingerprint coating, anti-static coating, slip control coating, optical control coating, such as, for example, an anti-reflective coating or viewing-angle-control coating, and conductive coating.

In some embodiments, the foundation organic layer and the barrier-stack organic layer, which may not be plasma-treated, are fabricated from an unsaturated organic material capable of polymerization. In one embodiment of the invention, the foundation organic layer and the barrier-stack organic layer are polymerization products of at least one monomer. At least one of the organic layers may be a cross-linked acrylate layer. In another embodiment, the foundation organic layer and the barrier-stack organic layer may be fabricated from low-molecular-weight addition-type polymers, natural oils, silicones, or condensation polymers. The thickness of the foundation organic layer varies depending on the topography of the substrate, and may fall between 0.1 to 1.0 micrometer, for example, it may equal about 0.5 micrometer. The thickness of the barrier-stack organic layer may fall between 0.1 to 0.5 micrometer, for example, may be about 0.25 micrometer.

The barrier layers and the organic layers may be substantially transparent. Each of the inorganic materials may be chosen from the group consisting of metal oxides, metal nitrides, metal carbides, metal oxynitrides, metal oxyborides, and combinations thereof. For example, any of the inorganic materials may be a metal oxide, for example, a silicon oxide, aluminum oxide, titanium oxide, indium oxide, tin oxide, indium tin oxide, tantalum oxide, zirconium oxide, niobium oxide, and combinations thereof. In one embodiment, the first inorganic material, the second inorganic material and the third inorganic material are the same inorganic material, for example, an aluminum oxide. The barrier layers may be deposited by thermal evaporation, electron beam evaporation, sputtering, reactive sputtering, chemical vapor deposition, plasma enhanced chemical vapor deposition, or electron cyclotron resonance source plasma enhanced chemical vapor deposition. In one embodiment of the invention, the barrier layers are deposited by reactive sputtering.

Each of the barrier layers may have a thickness ranging from 50 to 500 Å, for example, about 300 Å. In one embodiment, the barrier-stack barrier layer includes three plies of the second inorganic material, where each ply of the second inorganic material has a thickness of about 100 Å. In one embodiment of the invention, the topmost isolation layer has a thickness ranging from 50 to 400 Å, for example about 300 Å.

In general, in another aspect, the invention features a multi-layer environmental barrier coating having a flexible substrate, a foundation barrier layer deposited over the flexible substrate, and at least two barrier stacks deposited over the foundation barrier layer. The foundation barrier layer includes at least one ply of a first inorganic material. Each of the barrier stacks comprises, in sequence, an organic layer that includes at least one ply of an organic material; and, thereover, a barrier-stack barrier layer including at least one ply of a second inorganic material. In one embodiment of the invention, the first inorganic material and the second inorganic material are the same inorganic material. The flexible substrate, the foundation barrier layer, and the at least two barrier stacks deposited over the foundation barrier layer may be substantially transparent.

In yet another aspect, the invention generally features a method of manufacturing a multi-layer environmental barrier coating, comprising the steps of providing a flexible substrate, depositing a foundation stack over the substrate, depositing at least one barrier stack over the foundation stack, and depositing over the at least one barrier stack a topmost isolation layer of an inorganic material. The step of depositing a foundation stack may include depositing a foundation barrier layer made of at least one ply of a first inorganic material over the flexible substrate, depositing an organic layer comprising at least one ply of an organic material over the foundation barrier layer, and polymerizing the organic material. The step of depositing at least one barrier stack over the foundation stack may include the steps of depositing a barrier-stack barrier layer, depositing an organic layer comprising at least one ply of an organic material over that barrier layer, and polymerizing the organic material. The method may also include the step of plasma-treating the substrate prior to depositing a foundation stack over the flexible substrate. Further, the method may include plasma-treating the foundation barrier layer prior to depositing a foundation organic layer. Further yet, the method may include plasma-treating the barrier-stack barrier layer prior to depositing a barrier-stack organic layer. Also, the method may conclude with plasma-treating the topmost isolation layer.

In one embodiment, the step of depositing a barrier-stack barrier layer includes depositing a first ply of a second inorganic material over the foundation stack and plasma-treating the first ply. This step may further include depositing a second ply of a third inorganic material over the first ply and plasma-treating the second ply.

Each of the barrier layers may be deposited using thermal evaporation, electron beam evaporation, sputtering, reactive sputtering, chemical vapor deposition, plasma enhanced chemical vapor deposition, or electron-cyclotron-resonance-source plasma-enhanced chemical vapor deposition. In a particular embodiment of the invention, the barrier layers are deposited by reactive sputtering. The organic layers may be polymerized using ultraviolet or electron beam (EB) curing.

In still another aspect, the invention features a method of fabricating a multi-layer environmental barrier coating on a flexible web substrate. The method includes the steps of providing first and second bi-directional rollers for handling the web substrate so that a travel path extends between the rollers and providing, in series along the travel path, a sequence of application stations including a first surface treater, at least one first inorganic deposition system, a second surface treater, a first curing system, a monomer deposition system, a second curing system, a third surface treater, at least one second inorganic deposition system, and a fourth surface treater. The rollers are operated to alternately draw the web substrate across the travel path in opposite directions, and the application stations are operated to apply a series of cross-linked organic and inorganic plies on the web substrate, so that the applied plies are arranged as a series of adjacent organic and inorganic layers each comprising at least one ply.

Embodiments of this aspect of the invention may include the following features. In one embodiment, a first applied layer is an inorganic layer. A final applied layer may also be an inorganic layer. All steps of the method of the invention may occur within a single vacuum chamber under vacuum conditions. A surface treater may operate on each inorganic ply following application thereof and before application of an organic layer thereover.

In one embodiment, operating the process stations causes sequential application of an inorganic layer, a organic layer, and another inorganic layer during a first travel of the web substrate between the rollers, followed by successive applications of an organic layer followed by an inorganic layer during subsequent travels of the web substrate between the rollers.

During a forward travel of the web substrate from the first roller to the second roller, the step of operating the application stations may include, as a first substep, sequentially activating the first surface treater, the at least one first inorganic deposition system, the second surface treater, the monomer deposition system, the second curing system, the at least one second inorganic deposition system, and the fourth surface treater so as to sequentially apply an inorganic layer, a organic layer, and another inorganic layer. Then, as a second substep, during a reverse travel of the web substrate from the second roller to the first roller, the method may include sequentially activating at least one of the third and fourth surface treaters, the monomer deposition system, the first curing system, the at least one first inorganic deposition system, and the first surface treater so as to apply an organic layer followed by an inorganic layer. Then, as a third substep, during a forward travel of the web substrate from the first roller to the second roller, the method may include sequentially activating at least one of the first and second surface treaters, the monomer deposition system, the second curing system, the at least one second inorganic deposition system, and the fourth surface treater so as to apply an organic layer followed by an inorganic layer. Finally, the second and the third steps may be repeated at least once.

In one embodiment, the at least one first inorganic deposition system and the at least one second inorganic deposition system each may include a sequential series of inorganic deposition subsystems that themselves each apply an inorganic ply. As used herein, the term “monomer” refers generally to any molecule capable of being applied under vacuum conditions and subsequently cross-linked. Thus, a monomer may be univalent or multivalent, and may, in fact, be an oligomer or a mixture of monomers and oligomers. A monomer may include different species having different functional groups cross-linked by different mechanisms, e.g., exposure to UV (or other actinic radiation), and subjection to a cross-linking agent or radical initiator.

### BRIEF DESCRIPTION OF THE DRAWINGS

In the drawings like reference characters generally refer to the same parts throughout the different views. The drawings are not necessarily to scale, emphasis instead generally being placed upon illustrating the principles of the invention.

FIG. 1A is a cross-section of a multi-layer barrier coating according to one embodiment of the invention.

FIG. 1B is a cross-section of an OLED coated with the multi-layer barrier coating shown in FIG. 1A.

FIG. 2 is a flow diagram of one embodiment of a method of the invention

FIG. 3 is a schematic of an apparatus useful for fabricating a coating according to different embodiments of the invention.

FIG. 4A is a flow diagram of one embodiment of a method of the invention utilizing the apparatus shown in FIG. 3.

FIG. 4B is a flow diagram of another embodiment of a method of the invention utilizing the apparatus shown in FIG. 3.

FIG. 4C is a flow diagram of yet another embodiment of a method of the invention utilizing the apparatus shown in FIG. 3.

### DETAILED DESCRIPTION OF THE PREFERRED EMBODIMENTS

A key aspect of the present invention involves construction of a multi-layer barrier coating on a flexible substrate with improved resistance to gas and liquid permeation. The following disclosed embodiments of the multi-layer barrier coating according to the invention typically comprise a composite structure with alternating polymer and inorganic layers, wherein the layer immediately adjacent to the flexible substrate and the topmost isolation layer may both be inorganic layers. The surface of each deposited inorganic layers is preferably (although not necessarily) plasma-treated prior to the deposition of the polymer layer thereon, while the surface of the polymer layers ordinarily need not be plasma-treated. The multi-layer barrier coating according to the embodiments of the invention is lightweight, preferably transparent, and has improved flexibility and resiliency, as well as resistance to cracking and delaminating.

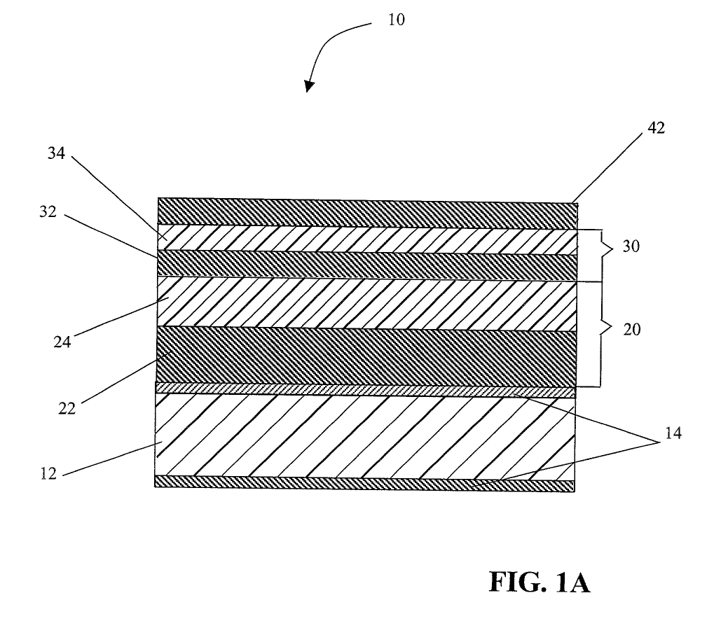

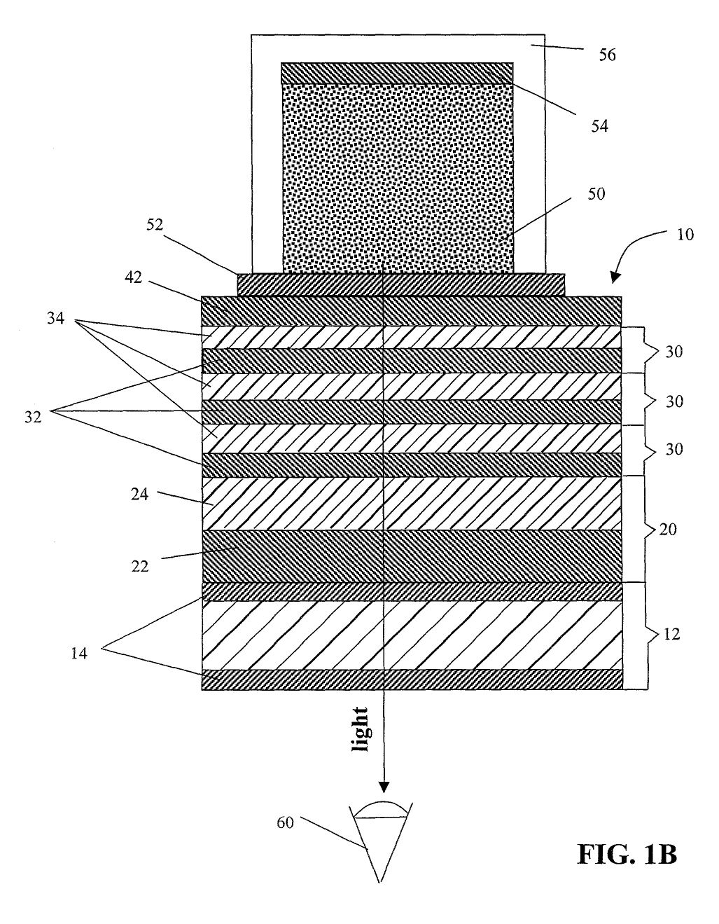

Referring to FIG. 1A, a multi-layer environmental barrier coating 10 according to one embodiment of the invention comprises a flexible substrate 12, a foundation stack 20, at least one barrier stack 30, and a topmost isolation layer 42, all of which are preferably substantially transparent to enable the viewer to observe the object being protected by the coating 10, especially if the object is an OLED used as part of a display.

The flexible substrate 12 can be fabricated from any flexible polymeric material having a glass transition temperature (T) sufficiently high so that the flexible substrate 12 does not excessively soften and deform during surface treatment and subsequent deposition of the coating thereon, or at process temperatures for patterning of the electrode layers. The flexible substrate 12 should also be resistant to water and solvents used in patterning processes, post-fabrication encapsulation, and in subsequent fabrication of articles employing the device. Non-limiting examples of materials characterized by a sufficiently high T_{g} that allow higher temperatures to be used for deposition of inorganic layers thereon, conversion (recrystallization, annealing, etc.) of deposited inorganic layers and patterning of inorganic layers include polyetherimides, polyether sulphones, polyimides and polynorbornenes. Accordingly, non-limiting examples of suitable materials for the flexible substrate 12 include polynorbornene, polyamide, polyethersulfone, polyimide, polyetherimide, polycarbonate, polyethelene naphthalate, polyester, and nylon. In one embodiment of the invention, the flexible substrate 12 substrate is made of a polyester film. At least one side of the flexible substrate 12 may contain at least one of the following functional coatings 14: an adhesion-enhancing coating; a protective hardcoat, such as, for example, a scratch-resistant coating; an anti-fingerprint coating, an anti-static coating, a slip control coating, or an optical control coating, such as, for example, an anti-reflective coating or viewing angle control coating. The side of the flexible substrate 12 upon which the barrier coating of the invention is deposited (the “inner side”) and the side facing the viewer (the “outer side”) may contain the same or different functional coatings 14. In one embodiment of the invention, the inner side of the flexible substrate 12 has an anti-reflective coating and the outer side of the flexible substrate 12 has a scratch-resistant coating thereon.

Referring still to FIG. 1A, the foundation stack 20 includes (or consists of) a foundation barrier layer 22 deposited onto the flexible substrate 12 and an organic layer 24 deposited over the foundation barrier layer 22. The multi-layer environmental barrier coating 10 also contains one or more barrier stacks 30 deposited over the foundation stack 20. Each barrier stack 30 includes (or consists of) a barrier-stack barrier layer 32 and an organic layer 34. A topmost isolation layer 42, fabricated of an inorganic material, is deposited over the topmost barrier stack 30.

The topmost isolation layer 42, the barrier-stack barrier layer 32 and the foundation barrier layer 22 include (or consist of) one or more plies of inorganic material (or materials). These plies can be made of the same inorganic material or different inorganic materials. Non-limiting examples of inorganic materials suitable for forming one or more plies of the layers 22, 32, and 42 include metal oxides, such as silicon oxide, aluminum oxide, titanium oxide, indium oxide, tin oxide, indium tin oxide, tantalum oxide, zirconium oxide, niobium oxide, and combinations thereof, and also include metal nitrides, metal carbides, metal oxynitrides, metal oxyborides, and combinations thereof. In one embodiment of the invention, some or all of the topmost isolation layer 42, the barrier-stack barrier layer 32, and foundation barrier layer 22 are fabricated of aluminum oxide. In another embodiment of the invention, some or all of these layers are fabricated of silicon oxide. In some embodiments, the layers 22, 32, and 42 have a thickness ranging from 50 to 500 Å, for example, about 300 Å each. In one embodiment, the foundation barrier layer 22 is about 100 Å thick. In another embodiment, the barrier-stack barrier layer 32 includes three plies of an inorganic material, each ply having a thickness of about 100 Å. In yet another embodiment of the invention, the topmost isolation layer 42 has a thickness of about 100 Å.

The foundation organic layer 24 and the barrier-stack organic layer 34 each include (or consist of) at least one ply of an organic material. In some embodiments of the invention, the organic material is a polymerizable and/or cross-linkable monomer or monomeric material.

As used herein, the term “monomer” refers generally to any molecule capable of being applied under vacuum conditions and subsequently cross-linked. Thus, a monomer may be univalent or multivalent, and may, in fact, be an oligomer or a mixture of monomers and oligomers. A monomer may include different species having different functional groups cross-linked by different mechanisms, e.g., exposure to UV (or other actinic radiation), and subjection to a cross-linking agent or radical initiator. Preferably, the layers 24 and 34 comprise an unsaturated organic material capable of polymerization, such as, for example, low-molecular-weight addition-type polymers, natural oils, silicones, condensation polymers, and other monomers and materials containing unsaturation which are capable of undergoing polymerization or cross-linking. As one of ordinary skill in the art will appreciate, unsaturated materials generally have one or more double bonds, or in some cases, triple bonds.

In one embodiment of the invention, the layers 24 and 34 comprise an acrylate-based organic material. Because of their reactivity, physical properties, and the properties of cured films formed from such components, polyfunctional acrylates are particularly useful monomeric materials. The general formula for such polyfunctional acrylates is:

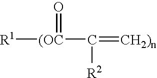

wherein:

R¹ is an aliphatic, alicyclic or mixed aliphatic-alicyclic radical derived from a compound of the formula R¹ (OH)ₘ;

R² is hydrogen, methyl, ethyl, propyl, butyl or pentyl;

n ranges from 2 to 4; and

m is 2 or more.

Such polyfunctional acrylates may also be used in combination with various monoacrylates, such as those having the formula:

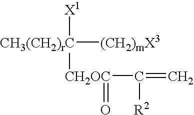

wherein:

R², r, and m are defined above;

X¹ is H or:

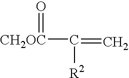

and

X³ is CN or COOR³ wherein R³ is an alkyl radical containing 1-4 carbon atoms. Most often, X³ is CN or COOCH_{3.}

It has generally not been considered feasible to evaporate high-molecular-weight, highly polar or ionic acrylates because of their very low vapor pressure. Evaporated acrylate coatings typically have been restricted to low-molecular-weight monomers, generally below a molecular weight of about 400. For example, PHOTOMER 4770 (Fitz Chemical), which is an amine acrylae, has a sufficiently high molecular weight and corresponding low vapor pressure that it cures in the evaporator before evaporating. Similarly, highly polar beta-carboxyethylacrylate (BCEA) also cures in the evaporator.

It has been found, however, that by mixing (e.g., diluting a low-vapor-pressure material into a higher-vapor-pressure material (which typically has a lower molecular weight, is less polar and is non-ionic), flash evaporation, condensation and curing can be obtained. For example, a mixture of 70% PHOTOMER 4770 and 30% diethylene glycol diacrylate can be successfully evaporated, condensed and cured. Similarly, a mixture of 70% tripropyleneglycol diacrylate (TRPGDA) and 30% beta-carboxyethyl acrylate (BCEA) can be readily evaporated, condensed and cured.

Ordinarily there is a tradeoff between the molecular weights of the high- and low-molecular-weight acrylates. Generally, the lower the molecular weight of the low-molecular-weight component, the higher the molecular weight of the higher molecular weight component can be for satisfactory evaporation and condensation.

It has been found that of the numerous suitable acrylates available, those based on or including propoxyl units —[O—C₃H₆]— generally produce the most resistant layers. Accordingly, non-limiting examples of the preferred acrylates include monomethoxytripropyleneglycol acrylate, monomethoxy-propoxylated neopentylglycol acrylate, dipropyleneglycol diacrylate (DPGDA), tripropyleneglycol diacrylate (TPGDA), propoxylated neopentylglycol diacrylate, propoxylated hexanediol diacrylate, propoxylated trimethylolpropane triacrylate, propoxylated glceryl triacrylate, and propoxylated pentaerythritol triacrylate.

In some embodiments of the invention, the foundation organic layer 24 has a thickness ranging from 0.1 to 1.0 micrometer, depending upon the surface topography of the flexible substrate 12. In a particular embodiment, the foundation organic layer 24 is about 0.5 micrometer thick. Further, in some embodiments, the barrier-stack organic layer 34 has a thickness ranging from 0.1 to 0.5 micrometer. In a particular embodiment of the invention, the barrier-stack organic layer 34 is about 0.25 micrometer thick.

Referring to FIG. 1B, the multi-layer environmental barrier coating 10 of the invention having the flexible substrate 12, the foundation stack 20, three barrier stacks 30, and a topmost isolation layer 42 is used on the viewer-facing side of an environmentally sensitive display device 50, thereby protecting the device 50 from moisture and gases. The rest of the device 50, including the opposite side of the device 50 containing electrode 54, is encapsulated using structures 56 known in the art. Every layer of the multi-layer environmental barrier coating 10 and the flexible substrate 12 is preferably substantially transparent at optical wavelengths to enable the viewer 60 to observe the device 50. The device 50 can be any display device that is sensitive to exposure to gases and liquids. Examples of environmentally sensitive display devices include, but are not limited to, liquid crystal displays (LCDs), OLEDs, light-emitting polymers (LEPs), electrophoretic displays, electroluminescent devices, and phosphorescent devices.

Still referring to FIG. 1B, for many applications, the first layer of the environmentally sensitive device 50 device on the viewer-facing side typically is a transparent electrode 52 fabricated from an inorganic material. Indium tin oxide is often used for this purpose because there are well-established methods for its deposition on polymer substrates, and established methods for its processing, such as etching and patterning, into discrete conductors subsequent to deposition. The transparent electrode 52 of the environmentally sensitive device 50 is in contact with the topmost isolation layer 42. Because the topmost isolation layer 42 comprises an inorganic material, it may provide an effective primer layer for the overlying inorganic electrode layer 52 of the environmentally sensitive device 50, and tolerate the thermal input accompanying its deposition. Also, the layer 42 is typically resistant to permeation of organic species originating on either side of it. As a result, it may operate to isolate the barrier stack from migratory organic contaminants originating in the environmentally sensitive device 50, as well as to isolate and the environmentally sensitive device 50 from migratory organic contaminants originating in the barrier stack 30.

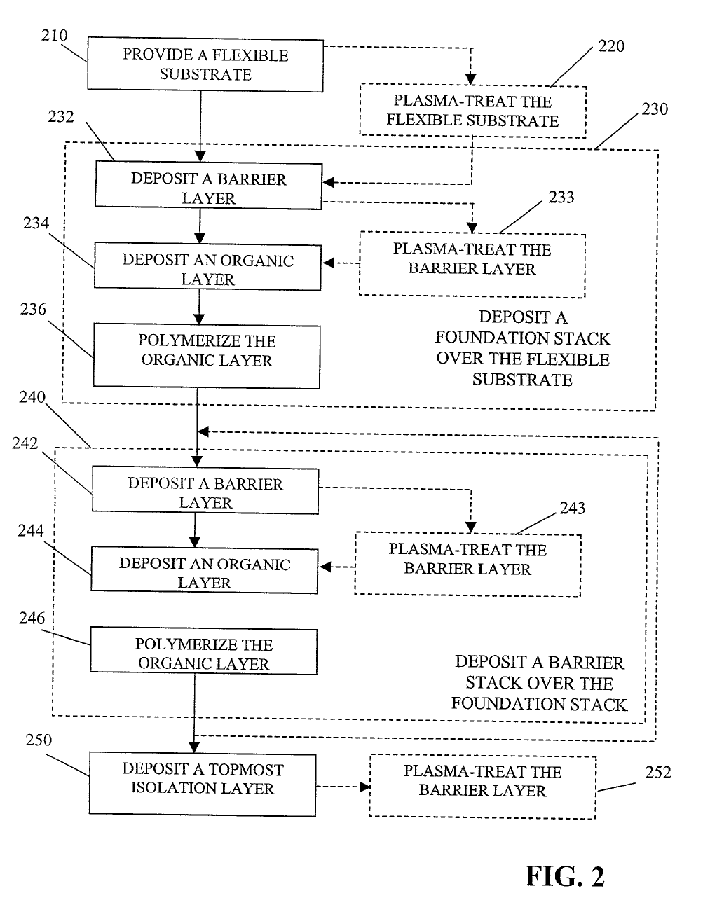

Referring now to FIGS. 1A and 2, a method of fabricating the multi-layer environmental barrier coating 10 includes providing a flexible substrate 12 (STEP 210) and, optionally, plasma-treating the flexible substrate (STEP 220). Plasma-treatment generally falls into two categories based on the working gas mixture used. For example, use of a chemically inert working gas, typically argon, limits modification and/or introduction of functional groups to species originating with the chemistry of the surface treated. In case of polyester, nitrogen-based functional groups such as amines or amides will not typically result from treatment with argon plasma because nitrogen is not part of the chemical makeup of polyester. Use of a reactive gas alone or in a mixture provides the potential for more significant modification of the surface treated. Returning to polyester, incorporation of nitrogen into the working gas introduces amines, amides, and other nitrogen-based compounds by providing the source of nitrogen required for their formation. Reactive gas mixtures can be used to treat difficult surfaces in order to effectuate more pervasive and/or more durable modification. For example, U.S. Pat. No. 5,469,560 to McPherson et al., incorporated herein by reference, discloses that a N₂O/CO₂ working gas mixture imparts a lasting surface enhancement. Accordingly, in one embodiment of the invention, the surface of the flexible substrate 12 is treated using reactive gas plasmas. U.S. Pat. Nos. 3,761,299 and 4,072,769 to Lidel and U.S. Pat. No. 5,567,072 to Hostettler et al., incorporated herein by reference, disclose a variety of polymer surface modifications by plasmas incorporating reactive gases. In another embodiment, plasma-treatment of the flexible substrate 12 (STEP 220) occurs in argon environment.

Generally, plasma-treatment of the flexible substrate 12 prior to deposition of the foundation stack is useful, for example, for substrates based on PET and similar chemistries, but is not necessary and may even be detrimental for substrate surfaces based on other chemistries, such as acrylates. Accordingly, in another embodiment of the invention, the step 220 is omitted and the foundation stack 20 is deposited over the flexible substrate 12 without plasma-treatment of the substrate 12.

Referring still to FIGS. 1A and 2, the method of the invention further includes depositing a foundation stack 20 over the flexible substrate (STEP 230). As understood in the art, plasma treatment of flexible polymer substrates generally improves adhesion of layers deposited thereon by various atmospheric or vacuum coating methods. Plasma treatment of polymer substrates results in increased surface energies accompanied by increased hydrophilic behavior, characteristics attributed to the introduction of polar functional groups, including, for example, —OH and —COOH. Plasma-treatment of the surface of a flexible polymer substrate (for example, a polyester film) may achieve additional advantages, including a softer, more deformable, more compliant and more adhesive surface. This effect is generally attributable to the presence of shorter polymeric chains and solvating low-molecular-weight organic species resulting from plasma-treatment-induced bond scission. Combined, the results of plasma treatment may allow the treated surface to remain adherent to an overlying layer, where a thermal coefficient of expansion ICE) of such overlying layer is different from the TCE of the substrate regardless of thermal input.

Plasma treatment has also been known in the art as a useful approach to removal of low-molecular-weight (typically, contaminant) species from a surface. For the surface of a flexible polymer substrate, the rate of removal will depend on the surface chemistry of the polymer substrate, the parameters of the plasma process used (power, reactive or non-reactive, and duration of exposure), and will be sensitive to variation in the surface chemistry of the substrate. Low-molecular-weight species not completely removed by plasma treatment, resulting from plasma treatment and/or those already resident in the film prior to treatment, are migratory and can contaminate at least the interfacial region or the entirety of another polymer layer deposited on the treated surface. Migration of organic species into organic layers is typically more pervasive than is a migration into an inorganic layer.

For the reasons cited above, plasma treatment of flexible polymer substrates is conveniently employed in the PML process to increase adhesion of polymer layers based on deposited and cured acrylates. Cross-linking of acrylate-based polymer layers is internal without useful chemical bonding to the underlying surface, and the considerable shrinkage resulting from cross-linking can generate interfacial stresses similar to those generated in response to thermal input (eating or cooling) into adjacent layers characterized by dissimilar TCEs. However, the increase in surface energy resulting from plasma treatment, which may improve adhesion, may at the same time increase hydrophilic behavior, which raises concerns about the impact of interfacial water. Also, in the PML process, condensation on a surface under a vacuum of low-molecular-weight species (for example where more than half the layer comprises species with molecular weights less than 400) as thin layers (for example less than 1 μm thick) creates an environment susceptible to contamination by migratory organic species.

Referring still to FIGS. 1A and 2, in order to create a foundation for deposition of the subsequent protective layer of the multi-layer barrier coating 10 (and thereby improve adhesion and reduce contamination of the coating 10 by the migratory organic species from the flexible substrate 12), the step of depositing the foundation stack 20 preferably comprises depositing at least one ply of an inorganic material onto the surface of a preferably, but not necessarily, plasma-treated flexible substrate 12 (STEP 232) thereby forming the foundation barrier layer 22; plasma treating the surface of the foundation barrier layer 22 (STEP 233), and then applying and polymerizing the foundation organic layer 24 (STEPS 234 and 236).

Methods for depositing the inorganic layer (STEP 232) include, but are not limited to, thermal evaporation, electron beam evaporation, sputtering, reactive sputtering, chemical vapor deposition (CVD), plasma-enhanced chemical vapor deposition (PECVD), and electron-cyclotron resonance-source plasma-enhanced chemical vapor deposition (ECR-PECVD).

As one of ordinary skill will recognize, methods for plasma-treatment in the PML environment useful to perform the step 233 are disclosed in, for example, U.S. Pat. Nos. 5,440,446 and 5,725,909 to Shaw et al. and 6,214,422 to Yializis, all of which are incorporated herein by reference.

Referring to FIG. 1A, in a particular embodiment of the invention, the foundation barrier layer 22 comprises aluminum oxide AlOₓ deposited via reactive sputtering. In this embodiment of the invention, the foundation barrier layer 22 comprising AlOₓ is thin, which generally improves flexibility. The foundation barrier layer 22 typically appears amorphous, which may be the result of low symmetry Al—OH hindering formation of crystalline AlOₓ at the low temperatures mandated by use of polymeric substrates. AlOₓ is not soluble in water and organic species, such as solvents, plasticizers, monomers, oligomers, polymers, etc., which are typically present in polymer film substrates. Migration of these species through the foundation barrier layer 22 is substantially minimized, thus limiting consideration of migratory moisture and organic species to that of possible contaminants for surfaces, grain boundaries and in interstitial spaces. Furthermore, the foundation barrier layer 22 formed from aluminum oxide AlOₓ presents a substantially uniform and generally less complex surface chemistry compared to, for example, to that provided by polymeric surfaces. The effects of plasma-treatment of a surface of the foundation barrier layer 22 are more reproducible than those resulting from the treatment of a surface of a more variable polymeric film. The benefits of plasma-treatment of the layer 22 may include removal of contaminants, dehydration, and modifying the effective surface area and density of the treated surface. Finally, the foundation barrier layer 22 formed from aluminum oxide AlOₓ provides an inert surface for subsequent deposition of an organic layer 24 using PML.

Referring again to FIGS. 1A and 2, application of the foundation organic layer 24 (STEPS 234 and 236) can be achieved by a number of methods, including, for example, PML, PECVD, or liquid multi-layer (LML) process.

As mentioned above, the PML approach is disclosed in, for example, U.S. Pat. Nos. 4,842,893 and 4,954,371 to Yializis, and U.S. Pat. No. 5,032,461 to Shaw et al., which are incorporated herein by reference. In one embodiment of the invention, the foundation organic layer 22 is vacuum-deposited onto the foundation barrier layer 24 by flash evaporation of an unsaturated organic material capable of polymerization, such as, for example, low-molecular-weight addition-type polymers, natural oils, silicones, condensation polymers, and other monomers, oligomers, resins or other materials containing unsaturation, which are capable of undergoing polymerization or cross-linking, and condensation of that material on the foundation barrier layer 24. (STEP 234). The deposited layer of unsaturated organic material is then polymerized in situ under continued vacuum conditions by, for example, electron beam or ultraviolet curing, or thermal exposure. (STEP 236). In a particular embodiment of the invention, the organic material is an acrylate-based monomer, which is polymerized using ultraviolet curing. Alternatively, as understood by those skilled in the art, the process of polymerization may involve incorporating a polymerization catalyst or initiator, for example, free radicals, into the monomer or other unsaturated organic material. The catalyst or initiator, which triggers the type of polymerization and/or cross-linking the material can undergo, is preferably incorporated in a latent form that can be activated after the deposition step.

Another approach to deposition of the foundation organic layer 22 (STEPS 234, 246) is the PECVD method disclosed in, for example, U.S. Pat. No. 5,902,641 to Affinito et al. as well as in U.S. Pat. Nos. 6,207,238, 6,207,239, and 6,224,948, all to Affinito, all of which are incorporated herein by reference. Under this approach, a liquid monomer is mixed with particles substantially insoluble in the liquid monomer, and the mixture is subsequently deposited by flash evaporation and cross-linked by plasma polymerization. Yet another method for depositing an organic coating on a substrate includes directing the vaporized organic material and the plasma towards the substrate in a vacuum and causing the vaporized organic material to condense and polymerize on the substrate in the presence of the plasma to form an organic coating. This method is described in U.S. Pat. Nos. 6,203,898 B1 and 6,348,237 B2 both to Kohler et al., both of which are incorporated herein by reference.

Still another approach to deposition of the foundation organic layer (STEPS 234, 246) is a LML process that essentially entails depositing fluid in a vacuum environment using methods and equipment normally used for atmospheric coating. This approach is described in U.S. Pat. Nos. 5,260,095, 5,395,644, and 5,547,508, all to Affinito, all of which are incorporated herein by reference.

Referring further to FIGS. 1A and 2, after the foundation stack 20 is deposited over the flexible substrate, a barrier stack 30 is applied over the foundation stack 20 (STEP 240). The step 240 may be repeated, if desired, to deposit additional barrier stacks 30. In some applications, for example when the device to be protected by the coating 10 is set to operate in a particularly adverse environment, additional thickness of the coating 10 may be desired. The need for increased thickness of the coating 10, however, is balanced against the need for flexibility of the coating 10, which generally decreases as the thickness of the coating 10 increases.

As discussed in connection with FIG. 1A, the barrier stack 30 includes a barrier-stack barrier layer 32 and a barrier-stack organic layer 34. The barrier-stack barrier layer 32 includes one or more sequentially deposited plies of inorganic material. In one embodiment of the invention, the barrier-stack barrier layer 32 consists of one aluminum oxide ply, which is about 300 Å thick. In another embodiment of the invention, the barrier-stack barrier layer 32 consists of three aluminum oxide plies, each ply having a thickness of about 100 Å. Similarly, the barrier-stack organic layer may include (or consist of one or more plies of organic material. Such composite structure of the layers 32 and 34 may compensate for unavoidable defects in the structure of the plies of the layer because a defect in one ply will generally be blocked by the subsequent overlying ply. Furthermore, such a multi-ply construction may provide structural stress relief and improve crack resistance and flexibility of the resulting layers.

The step of depositing the barrier stack 30 (STEP 240) begins with deposition of a barrier-stack barrier layer 32 via, for example, physical vapor deposition, over the surface of the foundation organic layer 24 (STEP 242). Following the optional plasma-treatment of the barrier-stack barrier layer 32 (STEP 243), the barrier-stack organic layer 34 is deposited over the barrier-stack barrier layer 32 and polymerized (STEPS 244, 246). Methods of deposition of the barrier-stack barrier layer 32 and the barrier-stack organic layer 34 are similar to those described above in connection with the deposition of the foundation barrier layer 22 and the foundation organic layer 24.

Following the deposition of one or more barrier stacks 30, the topmost isolation layer 42 is deposited over the polymerized barrier-stack organic layer 34 of the topmost barrier stack 30 (STEP 250). Methods of deposition of the topmost isolation layer 42 are similar to those described above in connection with the deposition of the foundation barrier layer 24. After the topmost isolation layer 42 is deposited, it may preferably be plasma-treated (STEP 252).

In a particular embodiment of the invention, the surfaces of the organic layers 24 and 34 are not plasma-treated prior to the deposition of the barrier-stack barrier layer 32 and the topmost isolation layer 42 respectively. Omission of the plasma treatment, although contrary to conventional PML practice, is consistent with a more complete consideration of plasma-treatment. The foundation barrier layer 22 and the barrier-stack barrier layer 32 of the multi-layer barrier coating 10 of the invention provide protective layers that typically are substantially uncontaminated with migratory organic species originating either in the underlying plasma-treated polyester surface or in any of the polymerized organic layers. Plasma-treatment of the barrier layers 22 and 32 following their deposition may further reduce the amount of contaminants that have migrated through or settled onto the surface from the atmosphere of the working chamber. Plasma-treatment of the barrier layers 22 and 32 may also modify the surface tension thereof through removal or agitation of the surface molecules. As a result of plasma-treatment, therefore, the surfaces of the barrier layers 22 and 32 may undergo both structural and chemical modification, which may improve surface conditions for subsequent deposition of the organic layers via PML (STEPS 234, 244).

As those skilled in the art will appreciate, contaminants, particularly at interfaces, are often linked to failure mechanisms for composite structures, and often account for interlayer adhesion deficiencies in multi-layer constructions. Accordingly, reduction or elimination of contaminants is highly desirable. Because plasma-treatment of the inorganic layers removes surface contaminants, the adjacent organic layers 24 and 34 according to the invention are generally subject to little contamination from migratory organic species that might otherwise be present on the surfaces of the barrier layers 22 and 32.

Furthermore, the thermal impact to the surfaces of the organic layers 24 and 34, which results from PVD deposition of the barrier layers 32 and 42 thereon, may be either an additional source of migratory species originating in thermal decompositions or it may liberate migratory species already present in the organic layers. It is, therefore, desirable to limit such thermal impact by not heating the surfaces of the organic layers. Thus, as described above, in a particular embodiment of the invention, plasma-treatment of the surface of the polymer layer prior to PVD deposition of the inorganic layer, which typically occurs at high temperatures, is avoided.

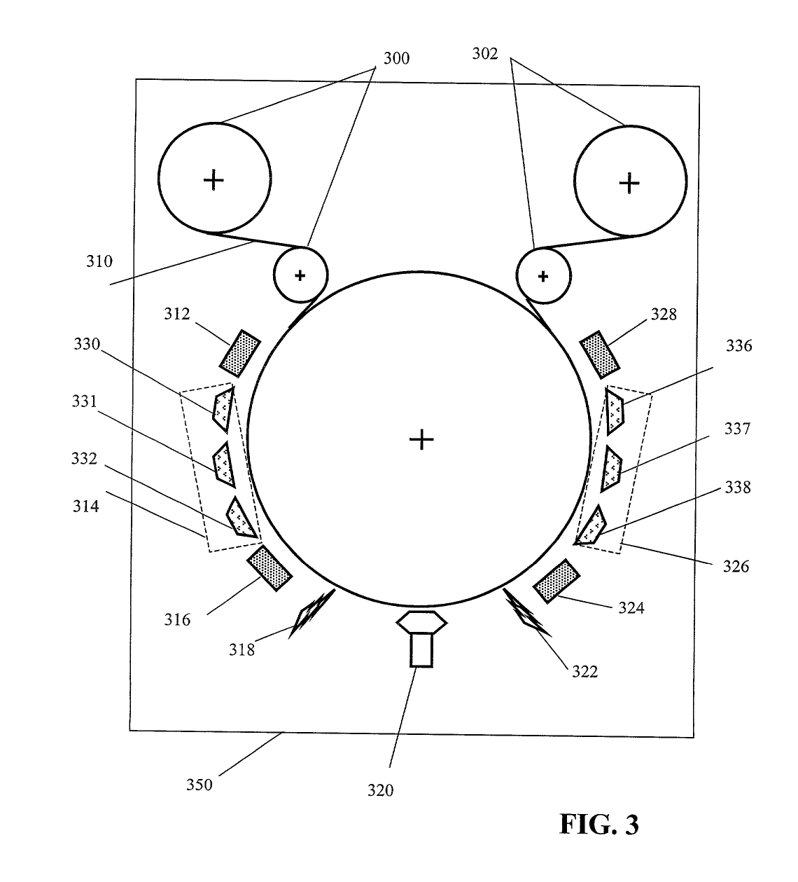

Referring to FIG. 3, an apparatus suitable for implementation of the methods of the present invention contains two sets of bi-directional rollers 300 and 302 for handling the web substrate 310 so that its travel path extends therebetween. The apparatus further contains, in series along the travel path, a sequence of application stations including a first surface treater 312, a first inorganic deposition system 314, a second surface treater 316, a first curing system 318, a monomer deposition system 320, a second curing system 322, a third surface treater 324, a second inorganic deposition system 326, and a fourth surface treater 328. In one embodiment of the invention, the first inorganic deposition system 314 and the second inorganic deposition system 326 each have three inorganic deposition subsystems 330, 331, and 332, and 336, 337, and 338, respectively. The rollers 300 and 302 and all of the application stations are located in the vacuum chamber 350. Not shown are conventional motors and related assemblies for actually rotating the rollers 300 and 302.

In some embodiments of the invention, the surface treaters 312, 316, 324 and 328 are plasma-treatment systems, described, for example, in U.S. Pat. Nos. 5,440,446 and 5,725,909 to Shaw et al. and U.S. Pat. No. 6,214,422 to Yializis. Further, inorganic deposition subsystems 330, 331, and 332, and 336, 337, and 338 may comprise reactive sputtering systems. Further yet, monomer deposition system 320 may comprise a flash evaporation system. Finally, the curing systems 318 and 322 may comprise sources of UV radiation or electron beam.

In operation, the rollers 300 and 302 alternately draw the web substrate 310 across the travel path in opposite directions; and the application stations deposit a series of cross-linked organic and inorganic plies on the web substrate 310, so that the applied plies are arranged as a series of adjacent organic and inorganic layers each comprising at least one ply.

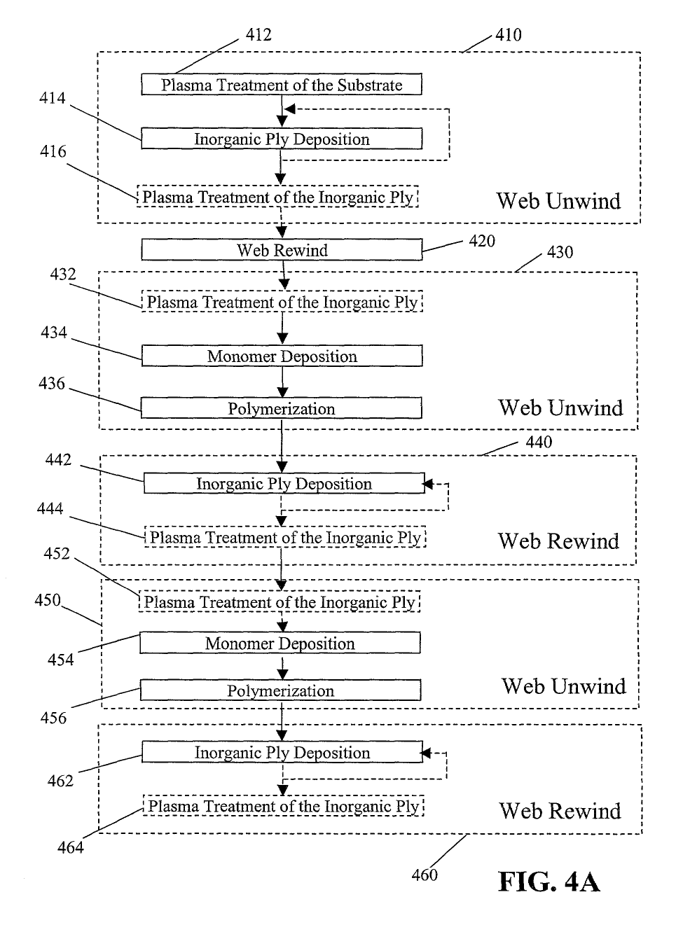

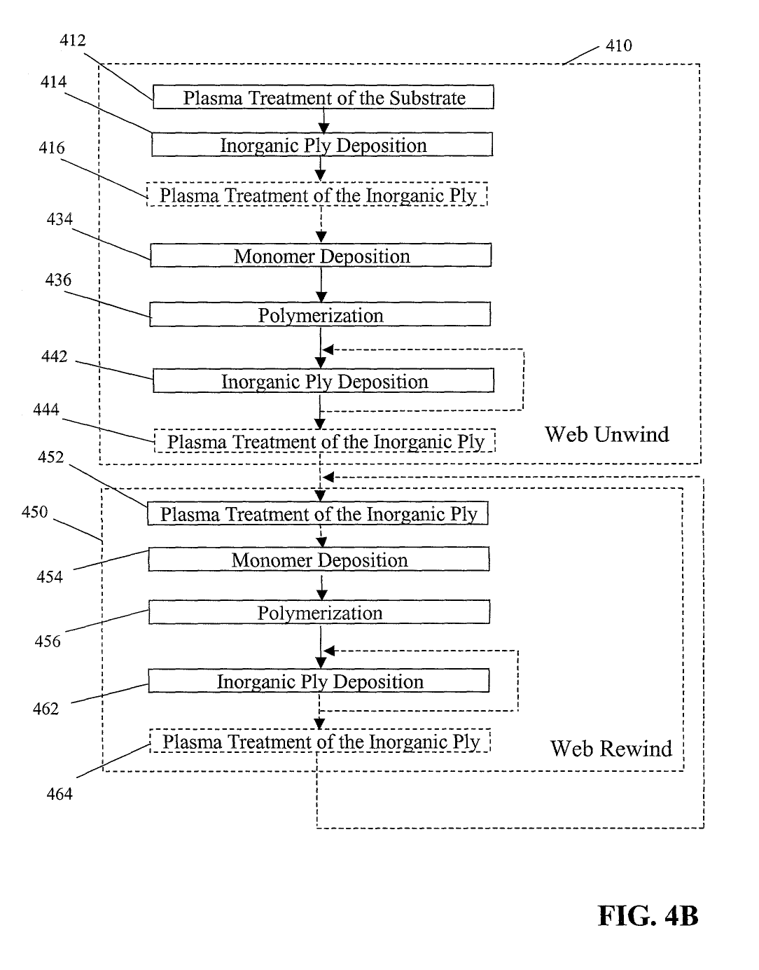

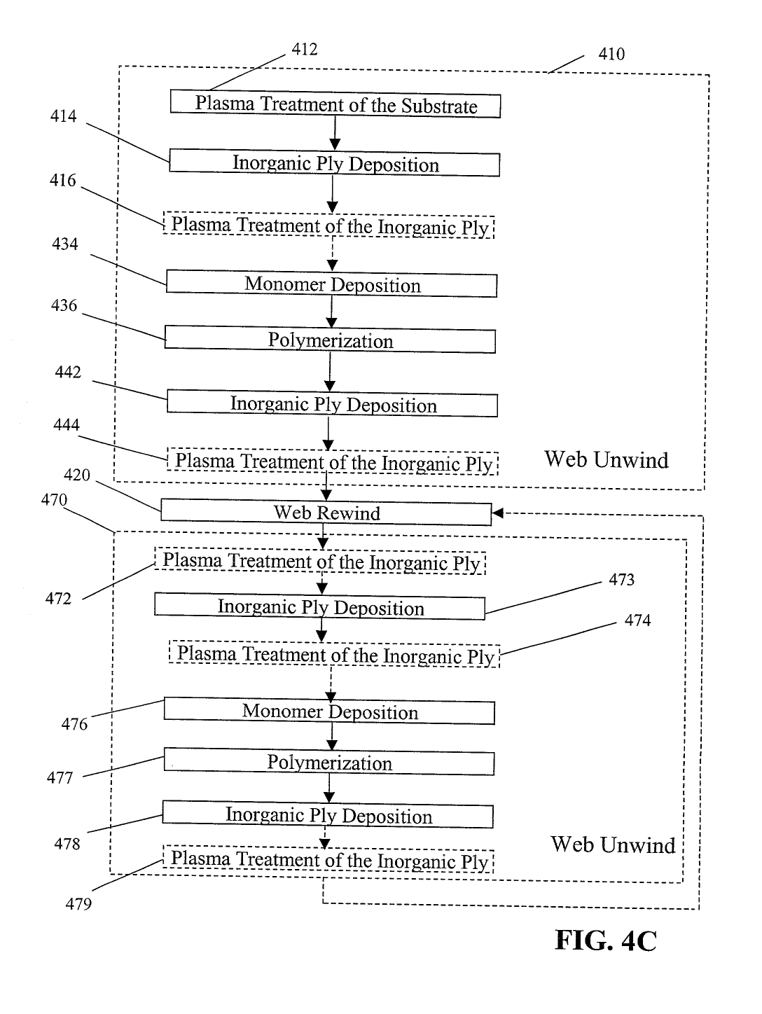

Referring to FIG. 4A, the multi-barrier environmental coating of the invention may be fabricated in discrete roll-to-roll steps using the apparatus shown in FIG. 3. In one embodiment of the invention, the rollers 300 and 302 unwind the web substrate 310 causing it to move from the rollers 300 towards the rollers 302. (STEP 410). As it travels from the rollers 300 to the rollers 302, the web substrate 310 is plasma-treated by the first surface treater 312 (STEP 412) and then at least one ply of an inorganic material (for example, aluminum oxide) is deposited onto the substrate 310 by any inorganic deposition subsystem of the first inorganic deposition system 314 (for example, by the inorganic deposition subsystem 330) (STEP 414). Further, the web substrate 310 with the inorganic layer deposited thereon may preferably be plasma-treated by the second surface treater 316 (STEP 416), and then rewound from the rollers 302 onto the rollers 300 bypassing all application stations (STEP 420). Subsequently, the web substrate 310 starts again to unwind (STEP 430) and is plasma-treated again during its travel towards the rollers 302 by the first surface treater 312 (STEP 432). The plasma-treatment with each unwind may reduce contamination resulting from face-to-back interactions that may have occurred in the wound roll of the web substrate 310.

Then, the web substrate 310 bypasses the inorganic deposition system 314, and one ply of an unsaturated organic material (for example, an actylate-based monomer) is deposited onto the plasma-treated inorganic layer using the monomer deposition system 320 (STEP 434). The resulting organic layer is polymerized, for example, by UV curing using the second curing system 322 (STEP 436). As a result, the first deposited inorganic layer combines with the next deposited polymeric layer to produce the improved foundation stack on the web substrate 310. The rollers 300 and 302 then rewind the web substrate 310 back onto the rollers 300 (STEP 440). During the travel of the web substrate 310, the inorganic deposition subsystems 330, 331, or 332 deposit at least one ply of an inorganic material (STEP 442), thereby forming a first barrier layer overlying the foundation layer. In this embodiment of the invention, preferably each of the inorganic deposition subsystems 330, 331, or 332 deposit one ply of an inorganic material. In a particular embodiment of the invention, each of the inorganic deposition subsystems 330, 331, or 332 deposit the same inorganic material, for example, aluminum oxide, which is also the same as the inorganic material of the foundation stack deposited in step 414. In another embodiment of the invention, each of the inorganic deposition subsystems 330, 331, or 332 deposits the same inorganic material, for example, silicone oxide, which is different from the inorganic material of the foundation barrier layer deposited in the step 414. In yet another embodiment of the invention, the inorganic deposition subsystems 330 and 332 deposit the same inorganic material, for example, aluminum oxide, and the inorganic deposition subsystems 331 deposits a different inorganic material, for example, silicon oxide. Finally, in still another embodiment of the invention, each of the inorganic deposition subsystems 330, 331, or 332 deposits different inorganic material.

Referring still to FIGS. 3 and 4A, the last ply of the barrier layer is plasma-treated by the first surface treater 312 (STEP 444). Subsequently, the rollers 300 and 302 unwind the web substrate (STEP 450) bypassing the inorganic deposition system 314. Optionally, the first surface treater 312 or the second surface treater 316 plasma-treats the web substrate during its travel (STEP 452). As mentioned above, plasma-treatment with each unwind reduces contamination resulting from face-to-back interactions that may have occurred in the wound roll of the web substrate 310. Then, the monomer deposition systems 320 deposit one ply of an unsaturated organic material (for example, an acrylate-based monomer) onto the barrier layer (STEP 454). After that, the resulting organic layer is polymerized by, for example, UV curing using the second curing system 322 (STEP 456), thereby forming a barrier stack overlying the foundation stack.

Steps 440 and 450 may be repeated if additional barrier stacks is desired. Finally, the rollers 300 and 302 rewind the web substrate 310 bypassing the monomer deposition system 320 (STEP 460) and one or more plies of an inorganic material are deposited by the inorganic deposition system 314, thereby forming a topmost isolation layer (STEP 462). The method optionally concludes with plasma-treatment of the resulting topmost isolation layer by the first surface treater 312 (STEP 464).

Alternatively, the multi-barrier environmental coating of the invention may be fabricated in a single roll-to-roll step using the apparatus shown in FIG. 3. Referring now to FIGS. 3 and 4B, in another embodiment of the invention, the rollers 300 and 302 unwind the web substrate 310 causing it to move from the rollers 300 towards the rollers 302. (STEP 410). During its travel from the rollers 300 to the rollers 302, the web substrate 310 is plasma-treated by the first surface treater 312 (STEP 412) and then at least one ply of an inorganic material (for example, aluminum oxide) is deposited onto the substrate 310 by the first inorganic deposition subsystem 330 (STEP 414). Further, the web substrate with the inorganic layer deposited thereon is preferably plasma-treated by the second surface treater 316 (STEP 416). Then, one or more plies of an unsaturated organic material (for example, an acrylate-based monomer) are deposited onto the plasma-treated inorganic layer using the monomer deposition system 320 (STEP 434). The resulting organic layer is polymerized, for example, by UV curing using the second curing system 322 (STEP 436). As a result, the first deposited inorganic layer combines with the next deposited polymeric layer to produce the improved foundation stack on the web substrate 310. As the web substrate continues to travel towards the rollers 302 one or more plies of the inorganic material are deposited by the inorganic deposition subsystems 336, 337, and 338 (STEP 442). As discussed above, each of the inorganic deposition subsystems 336, 337, and 338 may deposit the same or a different inorganic material, which is either the same or different than the inorganic material of the foundation stack deposited by the first deposition system 314. Subsequently, the fourth surface treater 328 plasma-treats the resulting barrier layer (STEP 444), and the rollers 300 and 302 start to rewind the web substrate 310 towards the rollers 300 (STEP 450). On its path, the web substrate 310 bypasses the fourth surface treater 328 and the second inorganic deposition system 326, and is plasma-treated by the third surface treater 324 (STEP 452).

Next, the monomer deposition system 320 deposits at least one ply of an unsaturated organic material (for example, an acrylate-based monomer) onto the barrier layer (STEP 454). The resulting organic layer is polymerized, for example, by UV curing using the first curing system 318 (STEP 456), thereby forming a barrier stack overlying the foundation stack. A composite construction of the organic layer may be advantageous because several deposited plies cross-link to each other at the same time they are internally cross-linking during curing, thereby achieving improved interlayer adhesion. As the web substrate 310 continues its travel, the inorganic deposition subsystems 330, 331, and 332 of the first deposition system 314 deposits one or more plies of an inorganic material, which, as discussed above, may be the same or a different material for each ply, thereby forming the second barrier layer (STEP 462). Finally, the first surface treater 312 plasma-treats the second barrier layer (STEP 464). If desired, the rollers 300 and 302 unwind the web substrate 310 and the steps 412, 434, 436, 442, 444 and 450 are repeated thereby creating additional barrier-stacks each consisting of an inorganic and organic layer. At the end of the process, the last applied layer is an inorganic layer.

In yet another embodiment of the invention, each ply of the inorganic material forming the barrier layer is deposited in a separate roll-to-roll pass, which may reduce internal stress in the barrier layer. Referring to FIGS. 3 and 4C, after the performing the steps 412, 414, 416, 434, and 436 described in connection with FIG. 4B above, one of the inorganic deposition subsystems 336, 337, or 338 of the second inorganic deposition system 326 deposits a first inorganic ply of the first barrier layer (STEP 442), which is then plasma-treated by the fourth surface treater 328 (STEP 444). Then the rollers 300 and 302 rewind the web substrate 310 back onto the rollers 300 bypassing all application stations (STEP 420). Next, the rollers 300 and 302 unwind the web substrate 310 (STEP 470). As it travels, the web substrate 310 is plasma-treated again by the first surface treater 312 (STEP 472), and receives the second inorganic ply of the first barrier layer deposited by the inorganic deposition subsystem 330 (STEP 473). The resulting first barrier layer is plasma-treated by the second surface treater 316 (STEP 474). Then, the barrier-stack organic layer is deposited by the monomer deposition system 320 as described in connection with the steps 434 and 436 above (STEPS 476, 477). As the web substrate 310 continues on its travel towards the rollers 302, a first inorganic ply of the second barrier layer is deposited by one of the inorganic deposition subsystems 336, 337, or 338 of the second inorganic deposition system 326 (STEP 478) and preferably plasma-treated by the fourth surface treater 328 (STEP 479).

At this point, the improved foundation stack, a first barrier layer comprising two plies of inorganic material, and a first polymeric layer, the latter two providing first barrier stack, and a topmost barrier layer comprising one ply of inorganic material, have been deposited. If desired, the steps 420 and 472, 473, 474, 476, 477, 478, and 479 are repeated to provide additional barrier stacks, while the inorganic layer is always the last to be applied. The last applied inorganic layer becomes the isolation layer and provides the surface on which the device to be protected by the coating is deposited and adhered.

As mentioned above, the apparatus shown in FIG. 3 may generate a wide variety of alternating compositions of the barrier layers. In one embodiment of the invention, each of the inorganic deposition subsystems 330, 331, 322, 336, 337, and 338 is capable of depositing a different inorganic material, so that the multi-layer barrier coating of the invention may comprise a complex plurality of barrier layers, where the number of plies comprising each barrier layer, as well as chemical composition of each barrier layer varies.

It will be apparent to those skilled in the art that various modifications and variations can be made to the above-described structure and methodology without departing from the scope or spirit of the invention.

1. A multi-layer environmental barrier coating, comprising:
a flexible substrate;
a foundation stack, comprising:
a foundation barrier layer comprising at least one ply of a first inorganic material deposited over the flexible substrate, and
an organic layer comprising at least one ply of an organic material deposited over the foundation barrier layer,
at least one barrier stack deposited over the foundation stack, the barrier stack comprising:
a barrier-stack barrier layer comprising at least one ply of a second inorganic material, and
an organic layer comprising at least one ply of an organic material deposited over the barrier-stack barrier layer; and
a topmost isolation layer comprising a third inorganic material deposited over the barrier stack, wherein at least one of the inorganic plies is plasma-treated.

2. The coating of claim 1 wherein the barrier-stack barrier layer further comprises at least one ply of a plasma-treated fourth inorganic material.

3. The coating of claim 1 wherein the flexible substrate is selected from the group consisting of polynorbornene, polyamide, polyethersulfone, polyimide, polyetherimide, polycarbonate, polyethelene naphthalate, polyester, and nylon.

4. The coating of claim 1 wherein the flexible substrate is substantially transparent.

5. The coating of claim 1 wherein the flexible substrate is plasma-treated.

6. The coating of claim 5 wherein the flexible substrate comprises a polyester film.

7. The coating of claim 6 wherein at least one side of the flexible substrate includes a functional coating selected from the group consisting of an adhesion-enhancing coating, scratch-resistant coating, anti-fingerprint coating, anti-static coating, slip control coating, anti-reflective coating, viewing angle control coating, and conductive coating.

8. The coating on claim 1 wherein the foundation organic layer and the barrier-stack organic layer are not plasma-treated.

9. The coating of claim 8 wherein the foundation organic layer and the barrier-stack organic layer comprise an unsaturated organic material capable of polymerization.

10. The coating of claim 9 wherein the foundation organic layer and the barrier-stack organic layer comprise polymerization products of at least one monomer.

11. The coating of claim 10 wherein at least one of the organic layers comprises a cross-linked acrylate layer.

12. The coating of claim 8 wherein the foundation organic layer and the barrier-stack organic layer are both selected from the group consisting of low-molecular-weight addition-type polymers, natural oils, silicones, and condensation polymers.

13. The coating of claim 9 wherein the foundation organic layer has a thickness ranging from 0.25 to 0.75 micrometer.

14. The coating of claim 13 wherein the foundation organic layer has a thickness of about 0.5 micrometer.

15. The coating of claim 9 wherein the barrier-stack organic layer has a thickness ranging from 0.15 to 0.35 micrometer.

16. The coating of claim 15 wherein the barrier-stack organic layer has a thickness of about 0.25 micrometer.

17. The coating of claim 1 wherein at least one barrier layer is substantially transparent.

18. The coating of claim 1 wherein at least one organic layer is substantially transparent

19. The coating of claim 1 wherein each of the inorganic materials are selected from the group consisting of metal oxides, metal nitrides, metal carbides, metal oxynitrides, metal oxyborides, and combinations thereof.

20. The coating of claim 1 wherein each of the inorganic materials comprise a metal oxide selected from the group consisting of: silicon oxide, aluminum oxide, titanium oxide, indium oxide, tin oxide, indium tin oxide, tantalum oxide, zirconium oxide, niobium oxide, and combinations thereof.

21. The coating of claim 1 wherein the first inorganic material, the second inorganic material and the third inorganic material are the same inorganic material

22. The coating of claim 19 wherein the first inorganic material, the second inorganic material and the third inorganic material comprise aluminum oxide.

23. The coating of claim 1 wherein the first inorganic material, the second inorganic material and the third inorganic material are deposited by thermal evaporation, electron beam evaporation, sputtering, reactive sputtering, chemical vapor deposition, plasma enhanced chemical vapor deposition, or electron cyclotron resonance source plasma enhanced chemical vapor deposition.

24. The coating of claim 1 wherein the first inorganic material, the second inorganic material and the third inorganic material are deposited by reactive sputtering.

25. The coating of claim 1 wherein each of the barrier layers has a thickness in the range from 50 to 500 Å.

26. The coating of claim 25 wherein each of the barrier layers has a thickness of about 300 Å.

27. The coating of claim 26 wherein the barrier-stack barrier layer comprises three plies of second inorganic material, each ply of second inorganic material having a thickness of about 100 Å.

28. The coating of claim 25 wherein the foundation barrier layer has a thickness of about 100 Å.

29. The coating of claim 1 wherein the topmost isolation layer has a thickness in the range from 50 to 400 Å.

30. The coating of claim 29 wherein the topmost isolation layer has a thickness of about 100 Å.

31. A multi-layer environmental barrier coating, comprising:
a flexible substrate;
a foundation barrier layer comprising at least one ply of a first inorganic material deposited over the flexible substrate; and
at least two barrier stacks deposited over the foundation barrier layer, each barrier stack comprising, in sequence:
an organic layer comprising at least one ply of an organic material; and
thereover, a barrier-stack barrier layer comprising at least one ply of a second inorganic material.

32. The coating of claim 31 wherein the first inorganic material and the second inorganic material is the same inorganic material.

33. The coating of claim 31 wherein the flexible substrate, the foundation barrier layer, and the at least two barrier stacks deposited over the foundation barrier layer are substantially transparent.

34. A method of manufacturing a multi-layer environmental barrier coating, the method comprising the steps of:
(a) providing a flexible substrate;
(b) depositing a foundation stack over the flexible substrate, comprising the steps of:
(i) depositing a foundation barrier layer comprising at least one ply of a first inorganic material over the flexible substrate,
(ii) depositing over the foundation barrier layer a foundation organic layer comprising at least one ply of an organic material, and
(iii) polymerizing the foundation organic layer;
(c) depositing at least one barrier stack over the foundation stack, comprising the steps of:
(i) depositing a barrier-stack barrier layer,
(ii) depositing a barrier-stack organic layer over the barrier-stack barrier layer, and
(iii) polymerizing the barrier-stack organic layer; and
(d) depositing over the at least one barrier stack a topmost isolation layer, the topmost isolation layer comprising at least one ply of a third inorganic material.

35. The method of claim 34 further comprising, prior to step (b), the step of plasma treating the flexible substrate.

36. The method of claim 34 wherein step (b) further comprises plasma-treating the foundation barrier layer prior to depositing over the foundation barrier layer a foundation organic layer.

37. The method of claim 34 wherein the step of depositing a barrier-stack barrier layer comprises depositing over the foundation stack a first ply of a second inorganic material and plasma treating the first ply.

38. The method of claim 34 wherein the step of depositing a barrier-stack barrier layer further comprises depositing over the first ply a second ply of a fourth inorganic material and plasma treating the second ply.

39. The method of claim 38 wherein the second inorganic material and the fourth inorganic material is the same inorganic material.

40. The method of claim 34 wherein each of the barrier layers and the topmost isolation layer are deposited using thermal evaporation, electron beam evaporation, sputtering, reactive sputtering, chemical vapor deposition, plasma enhanced chemical vapor deposition, or electron cyclotron resonance source plasma enhanced chemical vapor deposition.

41. The method of claim 34 wherein each of the barrier layers and the topmost isolation layer are deposited using reactive sputtering.

42. The method of claim 34 wherein the organic layer is polymerized using ultraviolet curing.

43. A method of fabricating a multi-layer environmental barrier coating on a flexible web substrate, the method comprising the steps of:
(a) providing first and second bi-directional rollers for handling the flexible web substrate, a travel path extending between the rollers;
(b) providing, in series along the travel path, a sequence of process stations comprising (i) a first surface treater,
(ii) at least one first inorganic deposition system,
(iii) a second surface treater,
(iv) a first curing system,
(v) a monomer deposition system,
(vi) a second curing system,
(vii) a third surface treater,
(viii) at least one second inorganic deposition system, and
(ix) a fourth surface treater;
(c) operating the rollers to alternately draw the flexible web substrate across the travel path in opposite directions; and
(d) operating the process stations to apply a series of organic and inorganic plies on the flexible web substrate, the applied plies being arranged as a series of adjacent organic and inorganic layers each comprising at least one ply.

44. The method of claim 43 wherein a first applied layer is an inorganic layer.

45. The method of claim 44 wherein a final applied layer is an inorganic layer.

46. The method of claim 43 wherein all steps occur within a single vacuum chamber under vacuum conditions.

47. The method of claim 43 wherein a surface treater operates on each inorganic ply following deposition thereof and before deposition of an organic ply thereover.

48. The method of claim 43 wherein the step of operating the process stations causes sequential deposition of an inorganic layer, a organic layer, and another inorganic layer during a first travel of the flexible web substrate between the rollers, followed by successive depositions of an organic layer followed by an inorganic layer during subsequent travels of the flexible web substrate between the rollers.

49. The method of claim 48 wherein the step of operating the process stations comprises:
(a) during a forward travel of the flexible web substrate from the first roller to the second roller, sequentially activating the at least one first inorganic deposition system, the second surface treater, the monomer deposition system, the second curing system, the at least one second inorganic deposition system, and the fourth surface treater so as to sequentially deposit an inorganic layer, an organic layer, and another inorganic layer;
(b) during a reverse travel of the flexible web substrate from the second roller to the first roller, sequentially activating at least one of the third and fourth surface treaters, the monomer deposition system, the first curing system, the at least one first inorganic deposition system, and the first surface treater so as to apply a organic layer followed by an inorganic layer;
(c) during a forward travel of the flexible web substrate from the first roller to the second roller, sequentially activating at least one of the first and second surface treaters, the monomer deposition system, the second curing system, the at least one second inorganic deposition system, and the fourth surface treater so as to apply a organic layer followed by an inorganic layer; and
(d) repeating steps (b) and (c) at least once.

50. The method of claim 49 wherein the step of operating the process stations further comprises activating the first surface treater prior to activating the at least one first inorganic deposition system during a forward travel of the flexible web substrate from the first roller to the second roller.

51. The method of claim 43 wherein each of the surface treaters is a plasma source.

52. The method of claim 43 wherein each of the curing systems is an ultraviolet radiation generator.

53. The method of claim 43 wherein the at least one first inorganic deposition system and the at least one second inorganic deposition system each comprise a sequential series of inorganic deposition systems that themselves each apply an inorganic ply.

54. The method of claim 43 wherein the flexible substrate is selected from the group consisting of polynorbornene, polyamide, polyethersulfone, polyimide, polyetherimide, polycarbonate, polyethelene naphthalate, polyester, and nylon.
